(19) United States
(12) Patent Application Publication
(10) Pub. No.: US 2009/0208652 A1
(43) Pub. Date: Aug. 20, 2009

(54) INK SET FOR INKJET RECORDING AND IMAGE RECORDING METHOD

(75) Inventors: Misato Sasada, Ashigarakami-gun (JP); Takafumi Hosokawa, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/371,252

(22) Filed: Feb. 13, 2009

(30) Foreign Application Priority Data
Feb. 20, 2008 (JP) 2008-039257

(51) Int. Cl. B05D 1/36; C08L 33/14

(52) U.S. Cl. 427/261; 524/558; 427/258

(57) ABSTRACT

An ink set for inkjet recording, including: an aqueous ink composition containing a pigment coated with a water-insoluble resin including a structural unit represented by the following formula (I), an organic solvent, a neutralizing agent, and water; and an aqueous liquid composition containing a component which aggregates the pigment in the aqueous ink composition when the aqueous liquid composition is mixed with the aqueous ink composition:

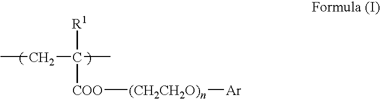

wherein R¹ represents a hydrogen atom or a methyl group, Ar represents an unsubstituted or substituted aromatic ring, and n represents an average number of repetition of 1 to 6.

### CROSS-REFERENCE TO RELATED APPLICATION

This application claims priority under 35 USC 119 from Japanese Patent Application No. 2008-039257, the disclosure of which is incorporated by reference herein.

### BACKGROUND OF THE INVENTION

1. Field of the Invention

The present invention relates to a two-liquid aggregation type ink set for inkjet recording, and an image recording method using the ink set.

2. Description of the Related Art

Various recording media for inkjet recording have been studied, and techniques for forming high-quality images are in demand. For inks for inkjet recording, coloring materials such as pigments have been studied as ink materials having water resistance and light resistance.

When recording on plain paper, however, there are cases when sufficient performance is not achieved in terms of color density, fixing property, and resolution. This is particularly the case in, for example, high speed inkjet recording. Therefore, suitable performance for recording is being sought in high speed recording conducted not by a shuttle scanning system but a single pass system wherein printing is achieved in a single head operation.

In order to achieve objectives such as high fixing property, enlargement of the color reproducible range of a secondary color, sufficient optical density in high speed printing, and prevention of bleeding when an image is formed on various recording media, a method has been proposed in which two liquids are used including a first liquid containing pigment particles and a second liquid containing a liquid composition for improving printability (see, for example, Japanese Patent Application Laid-Open (JP-A) No. 2007-261206). In this method, the above-described objects can be achieved through appropriate control of the particle diameter of the pigment contained in the first liquid; specifically, appropriate control of the content amount of pigment particles having a particle diameter of 150 nm or more.

However, in the above-described method, during image formation, directional failure of ink ejection may be caused, for example, by adhesion and drying of an aggregate of the mixture of the first and second liquids near the print heads, which have been formed as a result of generation of mist during ejection of the first and second liquids. Since the aggregate cannot be removed by liquid ejected thereafter, and removability (maintainability) of the attached aggregate is insufficient, this may result in defects such as white spots in the recorded image.

### SUMMARY OF THE INVENTION

According to an aspect of the invention, there is provided an ink set for inkjet recording, comprising:

an aqueous ink composition containing a pigment coated with a water-insoluble resin including a structural unit represented by the following formula (I), an organic solvent, a neutralizing agent, and water; and

an aqueous liquid composition containing a component which aggregates the pigment in the aqueous ink composition when the aqueous liquid composition is mixed with the aqueous ink composition:

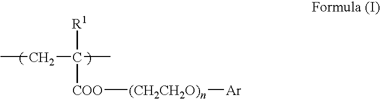

wherein R¹ represents a hydrogen atom or a methyl group, Ar represents an unsubstituted or substituted aromatic ring, and n represents an average number of repetition of 1 to 6.

### DETAILED DESCRIPTION OF THE INVENTION

The ink set for inkjet recording of the invention and the image recording method of the invention using the ink set are described below in detail.

<Ink Set for Inkjet Recording>

The ink set for inkjet recording of the invention includes an aqueous ink composition and an aqueous liquid composition, and when the aqueous ink composition is brought into contact with the aqueous liquid composition, aggregation is caused to form an image. The ink set may include one aqueous ink composition and one aqueous liquid composition, or may include a plurality of at least either of the two compositions.

(Aqueous Ink Composition)

In the ink set for inkjet recording of the invention, the aqueous ink composition includes a pigment coated with a water-insoluble resin including a structural unit represented by the following formula (I) (which hereinafter may be referred to as “resin-coated pigment”), an organic solvent, a neutralizing agent, and water. Optionally, the ink composition may further include other components such as resin fine particles, a polymer latex, and a surfactant.

In the invention, as a coloring agent, a pigment coated with a water-insoluble resin including a structural unit represented by the formula (I) is contained in an ink liquid. As a result, adhesion or deposition of aggregate at the liquid ejection portion, which is formed by the contact between the aqueous ink composition and the aqueous liquid composition at the time of recording, may be impeded, and the removal of the aggregate from the liquid ejection portion may be facilitated when the aggregate is attached thereto. Therefore, the decrease of the maintenance frequency of the ejection apparatus and improvement of the maintainability of the apparatus may also be achieved, directional failure of ink ejection at the time of recording is suppressed, and the occurrence of image defects such as white spots is prevented, whereby high image resolution may be achieved.

—Resin-Coated Pigment—

The aqueous ink composition in the invention includes at least one pigment (resin-coated pigment) coated with a water-insoluble resin including a structural unit represented by the following formula (I) (which hereinafter may be referred to as “water-insoluble resin in the invention”). The resin-coated pigment in the invention may be wholly or partially coated with the water-insoluble resin in the invention.

<Structural Unit Represented by Formula (I)>

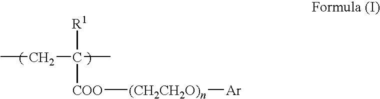

In the formula (I), R¹ represents a hydrogen atom or a methyl group, preferably a methyl group.

Ar represents an unsubstituted or substituted aromatic ring. Examples of substituents on the aromatic ring may include a halogen atom, an alkyl group, an alkoxy group, a hydroxy group, and a cyano group. The aromatic ring may form a condensed ring. Examples of the condensed ring include a condensed aromatic ring having eight or more carbon atoms, an aromatic ring condensed with a heterocycle, and two or more aromatic rings linked to each other.

The “condensed aromatic ring having eight or more carbon atoms” refers to a condensed aromatic ring having at least two or more benzene rings, or an aromatic compound having eight or more carbon atoms including at least one aromatic ring and an alicyclic hydrocarbon condensed with the aromatic ring. Specific examples include naphthalene, anthracene, fluorene, phenanthrene, and acenaphthene.

The “aromatic ring condensed with a heterocycle” refers to a compound produced by condensation between an aromatic compound (preferably a benzene ring) containing no heteroatom, and a cyclic compound containing a heteroatom. The heteroatom-containing cyclic compound is preferably a five-membered or six-membered ring. The heteroatom is preferably a nitrogen atom, an oxygen atom, or a sulfur atom. The heteroatom-containing cyclic compound may contain multiple heteroatoms. In this case, the heteroatoms may be the same or different from each other. Specific examples of the aromatic ring condensed with a heterocycle include phthalimido, acridone, carbazole, benzoxazole, and benzothiazole.

The aromatic ring represented by Ar binds to the main chain of the water-insoluble resin via an ester group and an ethylene oxide chain. Since the aromatic ring is not directly linked to the main chain, an adequate distance is kept between the hydrophobic aromatic ring and the hydrophilic structural unit, so that the water-insoluble resin readily interacts with the pigment and is firmly adsorbed thereon, thus improving the dispersibility of the pigment.

In particular, Ar is preferably an unsubstituted benzene ring or an unsubstituted naphthalene ring, and particularly preferably an unsubstituted benzene ring.

n represents the average number of repetition of the ethyleneoxy chain in the water-insoluble resin of the resin-coated pigment contained in the aqueous ink composition, and is from 1 to 6, preferably from 1 to 2.

Specific examples of the monomer for forming the structural unit represented by the formula (I) may include phenoxyethyl (meth)acrylate and the following monomers.

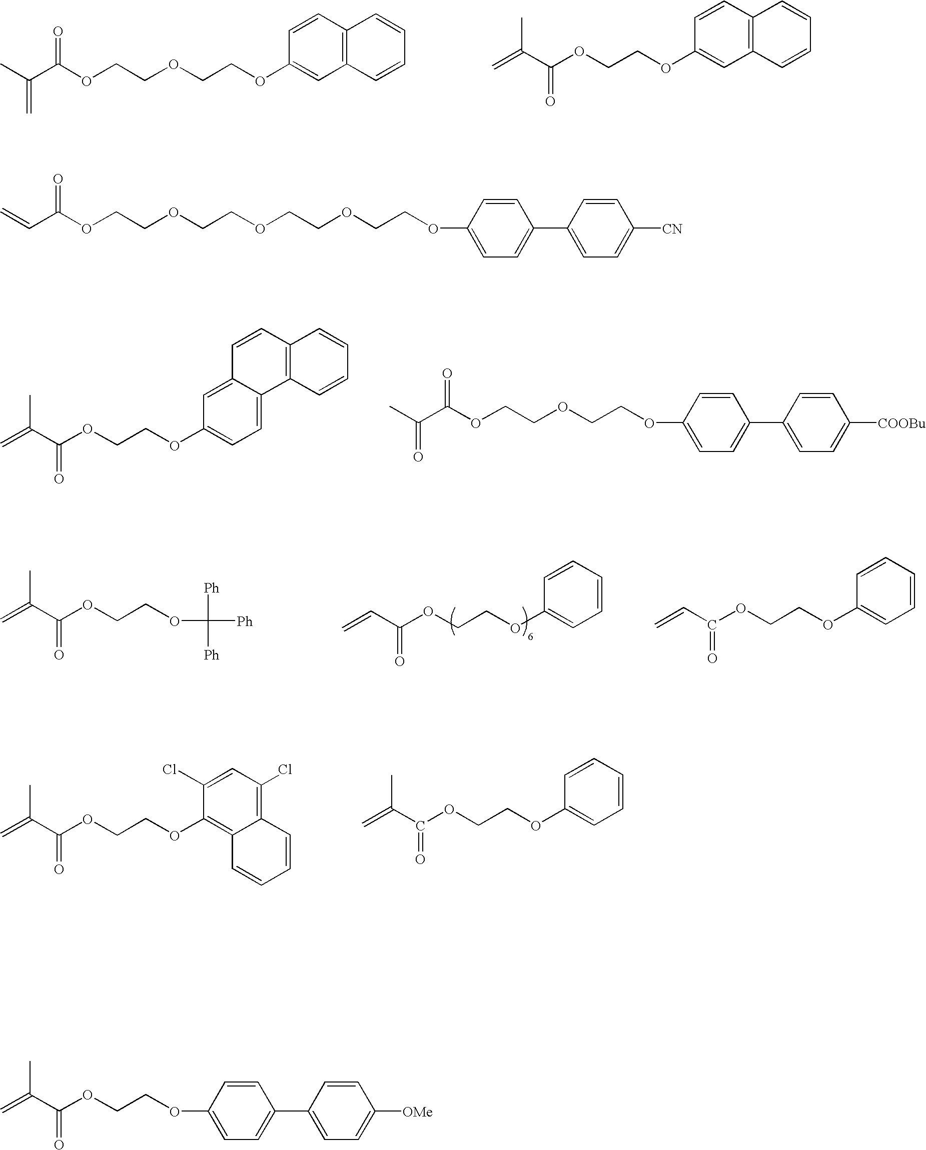

In the structural unit represented by the formula (I), from the viewpoint of dispersion stability, it is particularly preferable that R¹ be a methyl group, Ar be an unsubstituted benzene ring, and n be from 1 to 2.

The content ratio of the structural unit represented by the formula (I) in the water-insoluble resin is preferably from 30 to 70% by mass, and more preferably from 40 to 50% by mass with respect to the total mass of the water-insoluble resin. When the content ratio is 30% by mass or more, excellent dispersibility is achieved, and when the content ratio is 70% by mass or less, the adhesion and deposition of the aggregate are inhibited, and excellent removability (maintainability) of the attached aggregate may be achieved, and the occurrence of image defects such as white spots may be inhibited.

The water-insoluble resin in the invention is preferably a resin including hydrophilic structural units (A) and hydrophobic structural units (B) in view of achieving stability in an aqueous ink, impeding the adhesion or deposition of aggregate, and facilitating the removal of the attached aggregate. The hydrophobic structural units (B) include the structural unit represented by the formula (I).

<Hydrophilic Structural Units (A)>

The hydrophilic structural units (A) are preferably derived from, for example, acrylic acid or methacrylic acid. The water-insoluble resin preferably includes a structural unit derived from acrylic acid and/or a structural unit derived from methacrylic acid. Other examples of the hydrophilic structural units (A) include a structural unit derived from a monomer containing a nonionic hydrophilic group, and specific examples thereof may include (meth)acrylates and (meth)acrylamides containing a hydrophilic functional group, and vinyl monomers (such as vinyl esters) containing a hydrophilic functional group.

Examples of the “hydrophilic functional group” include a hydroxy group, an amino group, an amide group (having an unsubstituted nitrogen atom), and the below-described alkylene oxides such as polyethylene oxide and polypropylene oxide.

The monomer for forming the hydrophilic structural unit containing a nonionic hydrophilic group is not particularly limited as long as it contains a functional group for forming a polymer, such as an ethylenically unsaturated bond, and a nonionic hydrophilic functional group. The monomer may be selected from known monomers. Specific examples of preferable monomers may include hydroxyethyl(meth)acrylate, hydroxybutyl(meth)acrylate, (meth)acrylamide, aminoethyl acrylate, aminopropyl acrylate, and (meth)acrylates containing an alkylene oxide polymer.

The hydrophilic structural units (A) containing a nonionic hydrophilic group may be formed through polymerization of corresponding monomers, or introduction of a hydrophilic functional group to the polymer chain after polymerization.

The hydrophilic structural unit containing a nonionic hydrophilic group is more preferably a hydrophilic structural unit having an alkylene oxide structure. From the viewpoint of hydrophilicity, the alkylene moiety in the alkylene oxide structure is preferably an alkylene moiety having 1 to 6 carbon atoms, more preferably an alkylene moiety having 2 to 6 carbon atoms, and particularly preferably an alkylene moiety having 2 to 4 carbon atoms. The degree of polymerization of the alkylene oxide structure is preferably from 1 to 120, more preferably from 1 to 60, and particularly preferably from 1 to 30.

It is also preferable that the hydrophilic structural unit containing a nonionic hydrophilic group be a hydrophilic structural unit containing a hydroxy group. The number of the hydroxy group in the structural unit is not particularly limited, and preferably from 1 to 4, more preferably from 1 to 3, and particularly preferably from 1 to 2 from the viewpoints of the hydrophilicity of the water-insoluble resin, and its compatibility with the solvent and other monomer during polymerization.

In the above, for example, the content ratio of the hydrophilic structural units depends on the content ratio of the below-described hydrophobic structural units (B). For example, when the water-insoluble resin consists of acrylic acid and/or methacrylic acid [hydrophilic structural units (A)] and the below-described hydrophobic structural units (B), the content ratio of the acrylic acid and/or methacrylic acid is calculated by “100−(mass percentage of hydrophobic structural units)”.

The hydrophilic structural units (A) may be used alone or in combination of two or more thereof.

<Hydrophobic Structural Units (B)>

The water-insoluble resin in the invention may further include a hydrophobic structural unit (B) other than the structural unit represented by the formula (I). Examples of the hydrophobic structural unit (B) may include structural units which do not belong to the hydrophilic structural units (A), (for example, those containing no hydrophilic functional group), for example, such as structural units derived from (meth)acrylates, (meth)acrylamides, styrenes, and vinyl monomers such as vinyl esters, and a hydrophobic structural unit containing an aromatic ring linked to an atom in the main chain via a linking group. These structural units may be used alone or in combination of two or more thereof.

Examples of the (meth)acrylates include methyl(meth)acrylate, ethyl(meth)acrylate, butyl(meth)acrylate, isobutyl(meth)acrylate, and hexyl(meth)acrylate. Among them, methyl(meth)acrylate, ethyl(meth)acrylate, and butyl(meth)acrylate are preferable, and methyl(meth)acrylate and ethyl(meth)acrylate are particularly preferable.

Examples of the (meth)acrylamides include N-cyclohexyl(meth)acrylamide, N-(2-methoxy ethyl)(meth)acrylamide, N,N-diallyl(meth)acrylamide, and N-allyl(meth)acrylamide.

Examples of the styrenes include styrene, methylstyrene, dimethylstyrene, trimethylstyrene, ethylstyrene, isopropylstyrene, n-butylstyrene, tert-butylstyrene, methoxystyrene, butoxystyrene, acetoxystyrene, chlorostyrene, dichlorostyrene, bromostyrene, chloromethylstyrene, hydroxystyrene protected with a group removable with an acidic substance (for example, t-Boc), methyl vinyl benzoate, α-methylstyrene, and vinylnaphthalene. Among them, styrene and α-methylstyrene are preferable.

Examples of the vinyl esters include vinyl acetate, vinyl chloroacetate, vinyl propionate, vinyl butylate, vinyl methoxy acetate, and vinyl benzoate. Among them, vinyl acetate is preferable.

The above-described “hydrophobic structural unit containing an aromatic ring linked to an atom in the main chain via a linking group” is preferably a structural unit wherein the proportion of the aromatic ring linked to an atom in the main chain of the water-insoluble resin via a linking group is from 15 to 27% by mass, more preferably from 15 to 25% by mass, and even more preferably from 15 to 20% by mass with respect to the water-insoluble resin.

The aromatic ring is linked to the atom in the main chain of the water-insoluble resin not directly but via a linking group. Therefore, an adequate distance is kept between the hydrophobic aromatic ring and the hydrophilic structural unit, so that the water-insoluble resin readily interacts with the pigment and is firmly adsorbed thereon, thus improving the dispersibility of the pigment.

The “hydrophobic structural unit containing an aromatic ring linked to an atom in the main chain via a linking group” is preferably a structural unit represented by the following formula (II) (excluding the structural unit represented by the formula (I)):

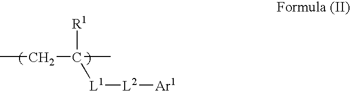

In the formula (II), R¹ represents a hydrogen atom, a methyl group, or a halogen atom. L¹ represents *-COO—, *-OCO—, *-CONR²—, *-O—, or a substituted or unsubstituted phenylene group, and R² represents a hydrogen atom or an alkyl group having 1 to 10 carbon atoms. In the group represented by L¹, an asterisk (*) denotes a bond connected to the main chain. The substituent of the phenylene group is not particularly limited, and examples thereof include a halogen atom, an alkyl group, an alkoxy group, a hydroxy group, and a cyano group.

L² represents a single bond or a divalent linking group having 1 to 30 carbon atoms. When L² is a divalent linking group, it is preferably a linking group having 1 to 25 carbon atoms, more preferably a linking group having 1 to 20 carbon atoms, and more preferably a linking group having 1 to 15 carbon atoms.

Among them, particularly preferable examples include an alkyleneoxy group having 1 to 25 (more preferably 1 to 10) carbon atoms, an imino group (—NH—), a sulfamoyl group, and divalent linking groups containing an alkylene group, such as an alkylene group having 1 to 20 carbon atoms (more preferably 1 to 15) or an ethylene oxide group [—(CH₂CH₂O)ₙ—, n=1 to 6], and combinations of two or more of these groups.

In the formula (II), Ar¹ represents a monovalent group derived from an aromatic ring.

The aromatic ring represented by Ar¹ is not particularly limited, and examples thereof include a benzene ring, a condensed aromatic ring having eight or more carbon atoms, an aromatic ring condensed with a heterocycle, and two or more benzene rings linked to each other. The details about the condensed aromatic ring having eight or more carbon atoms and the aromatic ring condensed with a heterocycle have been described above.

Specific examples of the monomer for forming the hydrophobic structural unit (B) are shown below. However, the invention is not limited to the following specific examples.

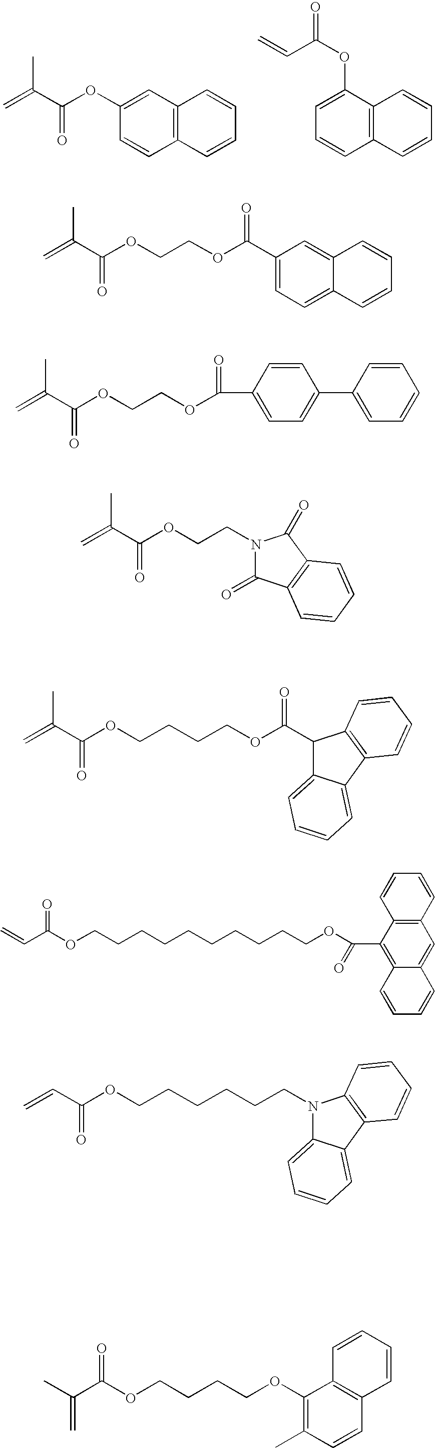

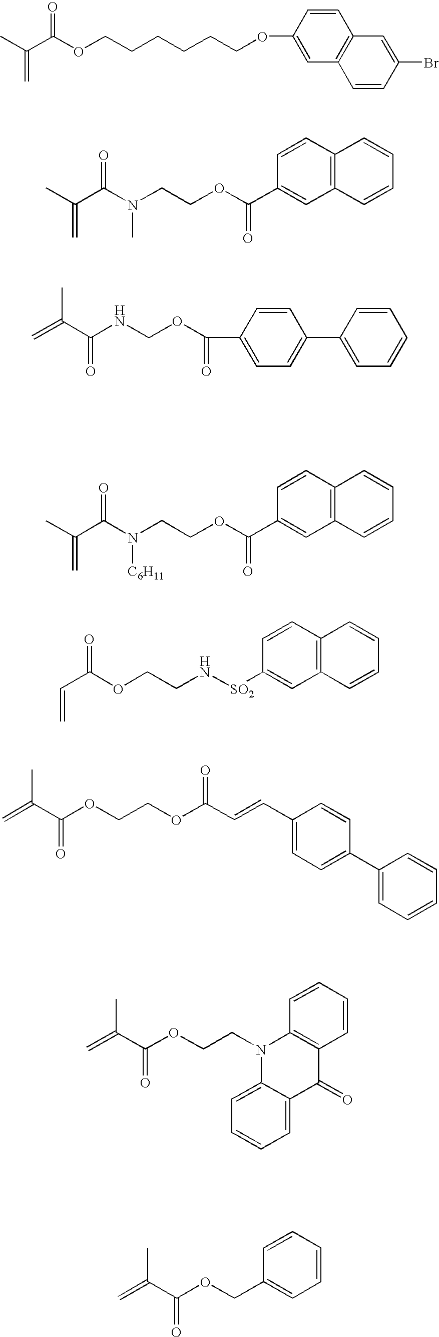

In the water-insoluble resin in the invention, although the ratio of the hydrophilic structural units (A) to the hydrophobic structural units (B) (including the structural unit represented by the formula (I)) depends on the degrees of the hydrophilicity and hydrophobicity of these components, the content of the hydrophilic structural units (A) in the water-insoluble resin is preferably 15% by mass or less. The content of the hydrophobic structural units (B) is preferably more than 80% by mass, and more preferably 85% by mass or more with respect to the total mass of the water-insoluble resin.

If the content of the hydrophilic structural units (A) is 15% by mass or less, the amount of the component dissolved alone in the aqueous medium is decreased, which results in the improvement of pigment properties such as dispersibility, whereby good ink ejection properties are achieved during inkjet recording.

The content ratio of the hydrophilic structural units (A) is preferably more than 0% by mass but 15% by mass or less, more preferably from 2 to 15% by mass, even more preferably from 5 to 15% by mass, and particularly preferably from 8 to 12% by mass with respect to the total mass of the water-insoluble resin.

In the invention, the acid number of the water-insoluble resin is preferably 30 mgKOH/g or more but 100 mgKOH/g or less, more preferably 30 mgKOH/g or more but 85 mgKOH/g or less, and particularly preferably 50 mgKOH/g or more but 85 mgKOH/g or less from the viewpoints of pigment dispersibility and storage stability.

The acid number is defined as the mass (mg) of KOH necessary for completely neutralizing 1 g of the water-insoluble resin, and measured by the method described in Japanese Industrial Standard (JIS K0070, 1992), the disclosure of which is incorporated by reference herein.

The weight average molecular weight (Mw) of the water-insoluble resin in the invention is preferably 30000 or more, more preferably from 30000 to 150000, even more preferably from 30000 to 100000, and particularly preferably from 30000 to 80000. If the molecular weight is 30000 or more, the water-insoluble resin may provide a good steric repulsion effect as a dispersant, and is readily adsorbed on the pigment owing to the steric effect.

The number average molecular weight (Mn) of the water-insoluble resin is preferably about 1,000 to 100,000, and particularly preferably about 3,000 to 50,000. When the number average molecular weight is within the above-described range, the water-insoluble resin may serve as a coating on the pigment or a coating of the ink composition. The water-insoluble resin in the invention is preferably used in the form of an alkali metal salt or an organic amine salt.

The molecular weight distribution of the water-insoluble resin in the invention (weight average molecular weight/number average molecular weight) is preferably from 1 to 6, and more preferably from 1 to 4. When the molecular weight distribution is within the above-described range, the resultant ink has improved dispersion stability and ejection stability.

The number average molecular weight and the weight average molecular weight are measured by the differential refractometer detection with THF as a solvent in a GPC analyzer using columns TSKgel GMHxL, TSKgel G4000 HxL and TSKgel G2000 HxL (manufactured by Tosoh Corporation), and is obtained by conversion with a polystyrene reference material.

The water-insoluble resin in the invention may be synthesized by any polymerization method, for example, solution polymerization, precipitation polymerization, suspension polymerization, bulk polymerization, or emulsion polymerization. The polymerization reaction may be carried out under a known system, such as a batch, semi-continuous, or continuous system. Initiation of the polymerization may be carried out with a radical initiator, or photoirradiation or radiation-irradiation. These methods of polymerization and initiation of polymerization are described in, for example, “Kobunshi Gosei Hoho” by Teiji Turuta, Revised Edition (published by Nikkan Kogyo Shimbun, Ltd., 1971) and “Kobunshi Gosei no Jikkenho” by Takayuki Ohtu and Masaetu Kinoshita (published by Kagaku-Dojin Publishing Company Inc., 1972) pp. 124 to 154.

Among these polymerization methods, a solution polymerization method using a radical initiator is preferable. Examples of the solvent used in the solution polymerization method include various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, and 1-butanol. These solvents may be used alone or in combination of two or more thereof, or may be mixed with water as a mixed solution. The polymerization temperature should be chosen in consideration of the molecular weight of the intended polymer and the type of the initiator, and is usually from 0° C. to 100° C., and is preferably from 50 to 100° C. The reaction pressure may be appropriately selected, and is usually from 1 to 100 kg/cm², and particularly preferably about from 1 to 30 kg/cm². The reaction period may be about 5 to 30 hours. The resultant resin may be subjected to purification treatment such as reprecipitation.

Specific examples of preferable water-insoluble resins of the invention are shown below. The invention is not limited to these examples.

| | | |
|---|---|---|
| 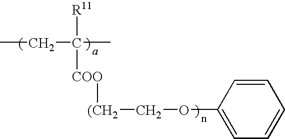 | 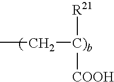 | 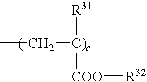 |

(a, b and c each represent the composition ratio of the unit (% by mass).)

| | R¹¹ | n | R²¹ | R³¹ | R³² | a | b | c | Mw |
|---|---|---|---|---|---|---|---|---|---|
| B-1 | CH₃ | 1 | CH₃ | CH₃ | —CH₃ | 60 | 9 | 31 | 35500 |
| B-2 | H | 1 | H | H | —CH₂CH₃ | 69 | 10 | 21 | 41200 |
| B-3 | CH₃ | 2 | CH₃ | CH₃ | —CH₃ | 70 | 11 | 19 | 68000 |
| B-4 | CH₃ | 4 | CH₃ | CH₃ | —CH₂(CH₃)CH₃ | 70 | 7 | 23 | 72000 |
| B-5 | H | 5 | H | H | —CH₃ | 70 | 10 | 20 | 86000 |
| B-6 | H | 5 | H | H | —CH₂CH(CH₃)CH₃ | 70 | 2 | 28 | 42000 |
| B-7 | CH₃ | 1 | CH₃ | CH₃ | —CH₂CH₃ | 50 | 11 | 39 | 44500 |
| B-8 | CH₃ | 1 | CH₃ | CH₃ | —CH₂CH₃ | 50 | 10 | 40 | 51200 |
| B-9 | H | 1 | H | H | —CH₂CH₃ | 45 | 11 | 44 | 48900 |
| B-10 | H | 1 | CH₃ | CH₃ | —CH₂CH₃ | 45 | 12 | 43 | 43600 |

| | | | | Mw |
|---|---|---|---|---|
| B-11 | 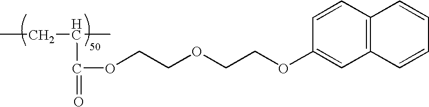 | 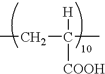 | 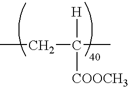 | 72400 |
| B-12 | 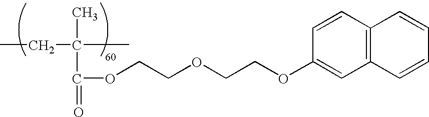 | 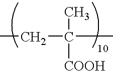 | 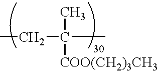 | 33800 |
| B-13 | 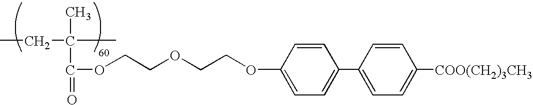 | 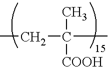 | 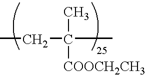 | 39200 |

<Pigment>

The pigment to be coated with the water-insoluble resin in the invention is further described below.

The pigment is not particularly limited, and may be appropriately selected according to the intended use. The pigment may be, for example, an organic or inorganic pigment.

Examples of the organic pigment include azo pigments, polycyclic pigments, dye chelates, nitro pigments, nitroso pigments, and aniline black. Among them, azo pigments and polycyclic pigments are more preferable.

Examples of the azo pigments include azo lakes, insoluble azo pigments, condensed azo pigments, and chelate azo pigments.

Examples of the polycyclic pigment include phthalocyanine pigments, perylene pigments, perinone pigments, anthraquinone pigments, quinacridone pigments, dioxazine pigments, indigo pigments, thio indigo pigments, isoindolinone pigments, and quinophthalone pigments.

Examples of the dye chelates include basic dye chelates and acidic dye chelates.

As the above-described organic pigments, examples of yellow ink pigments include C. I. Pigment Yellow 1,2,3,4,5,6,7, 10, 11, 12, 13, 14, 14C, 16, 17, 24, 34, 35, 37, 42, 53, 55, 65, 73, 74, 75, 81, 83, 93, 95, 97, 98, 100, 101, 104, 108, 109, 110, 114, 117, 120, 128, 129, 138, 150, 151, 153, 154, 155, and 180.

Examples of magenta ink pigments include C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48(Ca), 48(Mn), 48:2, 48:3, 48:4, 49, 49:1, 50, 51, 52, 52:2, 53:1, 53, 55, 57(Ca), 57:1, 60, 60:1, 63:1, 63:2, 64, 64:1, 81, 83, 87, 88, 89, 90, 101 (red oxide), 104, 105, 106, 108 (cadmium red), 112, 114, 122 (quinacridone magenta), 123, 146, 149, 163, 166, 168, 170, 172, 177, 178, 179, 184, 185, 190, 193, 202, 209, 219, and 269, and C. I. Pigment Violet 19. Among them, C. I. Pigment Red 122 is particularly preferable.

Examples of cyan ink pigments include C. I. Pigment Blue 1, 2, 3, 15, 15:1, 15:2, 15:3, 15:34, 16, 17:1, 22, 25, 56, and 60, C. I. Vat Blue 4,60, and 63. Among them, C. I. Pigment Blue 15:3 is particularly preferable.

Examples of the inorganic pigments include titanium oxide, iron oxide, calcium carbonate, barium sulfate, aluminium hydroxide, barium yellow, cadmium red, chrome yellow, and carbon black. Among them, carbon black is particularly preferable. The carbon black may be produced by a known method such as a contact method, a furnace method, or a thermal method.

As black pigments, specific examples of carbon black may include, but not limited to, RAVEN 7000, RAVEN 5750, RAVEN 5250, RAVEN 5000 ULTRA II, RAVEN 3500, RAVEN 2000, RAVEN 1500, RAVEN 1250, RAVEN 1200, RAVEN 1190 ULTRA II, RAVEN 1170, RAVEN 1255, RAVEN 1080, RAVEN 1060, and RAVEN 700 (manufactured by Columbian Carbon Company), REGAL 400R, REGAL 330R, REGAL 660R, MOGUL L, BLACK PEARLS L, MONARCH 700, MONARCH 800, MONARCH 880, MONARCH 900, MONARCH 1000, MONARCH 1100, MONARCH 1300, and MONARCH 1400 (manufactured by Cabot Corporation), COLOR BLACK FW1, COLOR BLACK FW2, COLOR BLACK FW2V, COLOR BLACK 18, COLOR BLACK FW200, COLOR BLACK S150, COLOR BLACK S160, COLOR BLACK S170, PRINTEX 35, PRINTEX U, PRINTEX V, PRINTEX 140U, PRINTEX 140V, SPECIAL BLACK 6, SPECIAL BLACK 5, SPECIAL BLACK 4A, and SPECIAL BLACK 4 (manufactured by Degussa), No. 25, No. 33, No. 40, No. 45, No. 47, No. 52, No. 900, No. 2200B, No. 2300, MCF-88, MA600, MA7, MA8, and MA100 (manufactured by Mitsubishi Chemical Corporation).

These pigments may be used alone or in combination of two or more thereof selected from one or more groups above.

The weight ratio (p:r) between the pigment (p) and the water-insoluble resin (r) in the invention is preferably from 100:25 to 100:140, and more preferably from 100:25 to 100:50. When the ratio of the water-insoluble resin is 25 or more, dispersion stability and abrasion resistance tend to improve, and when 140 or less, dispersion stability tends to improve.

The resin-coated pigment (microcapsulated pigment) in the invention may be produced from a water-insoluble resin and a pigment by a known physical or chemical method such as that described in JP-A Nos. 9-151342, 10-140065, 11-209672, 11-172180, 10-25440, and 11-43636. Specific examples of the method include the phase inversion method and acid precipitation method described in JP-A Nos. 9-151342 and 10-140065. Of these methods, the phase inversion method is preferable from the viewpoint of dispersion stability.

a) Phase Inversion Method

Basically, the phase inversion method is a self dispersion (phase inversion emulsification) method comprising dispersing in water a mixed melt of a pigment and a resin having self dispersivity or solubility. The mixed melt may contain the curing agent or a polymer compound. The mixed melt refers to a state where undissolved components are mixed and/or a state where dissolved components are mixed. Details about the “phase inversion method” are described in JP-A No. 10-140065.

b) Acid Precipitation Method

The acid precipitation method is a method for producing a microcapsulated pigment, including steps of preparing a hydrous cake of a resin and a pigment, and neutralizing part or all of the anionic groups of the resin in the hydrous cake using a basic compound.

The acid precipitation method specifically includes steps of: (1) dispersing a resin and a pigment in an alkaline aqueous medium, and optionally heating the dispersion for gelation of the resin; (2) adjusting the pH to a neutral or acidic value thereby hydrophobizing the resin to strongly attaching the resin to the pigment; (3) optionally carrying out filtration and water washing to obtain a hydrous cake; (4) neutralizing part or all of the anionic groups of the resin in the hydrous cake using a basic compound, and then re-dispersing it in an aqueous medium; and (5) optionally heating the dispersion for gelation of the resin.

The phase inversion method and acid precipitation method are detailed in JP-A Nos. 9-151342 and 10-140065.

In the aqueous ink composition in the invention, the resin-coated pigment in the invention may be prepared from a water-insoluble resin including the structural unit represented by the formula (I) through the preparation method for preparing a dispersion of the resin-coated pigment including the following steps (1) and (2). The aqueous ink composition of the invention may be prepared by the above-described preparation method followed by preparing an aqueous ink from the obtained dispersion of the resin-coated pigment, water, and an organic solvent.

Step (1): A mixture containing a water-insoluble resin including the structural unit represented by the formula (I), an organic solvent, a neutralizing agent, a pigment, and water is dispersed with a stirrer or the like to obtain a dispersion.

Step (2): The organic solvent is removed from the dispersion.

The stirring method is not particularly limited, and may use a common mixing stirrer or optionally a disperser such as an ultrasonic disperser, a high-pressure homogenizer, or a bead mill.

Examples of the organic solvents preferable herein include alcohol solvents, ketone solvents, and ether solvents. Examples of the alcohol solvents include isopropyl alcohol, n-butanol, t-butanol, and ethanol. Examples of the ketone solvents include acetone, methyl ethyl ketone, diethyl ketone, and methyl isobutyl ketone. Examples of the ether solvents include dibutyl ether and dioxane. Among these solvents, ketone solvents such as methyl ethyl ketone and alcohol solvents such as isopropyl alcohol are preferable, and methyl ethyl ketone is even more preferable.

The neutralizing agent is used for forming an emulsion or dispersion wherein part or all of the dissociative groups is neutralized, and the specific water-insoluble resin is stable in water. The details about the neutralizing agent will be described later.

In the step (2), the organic solvent is evaporated from the dispersion prepared in the step (1) by a common procedure such as vacuum distillation to convert the phase into a water system, thereby obtaining a dispersion of resin-coated pigment particles, the particle surface of the pigment being coated with the water-insoluble resin. The obtained dispersion is substantially free of the organic solvent. The amount of the organic solvent is preferably 0.2% by mass or less, and more preferably 0.1 % by mass or less.

More specifically, for example, the above-described method includes steps of: (1) mixing an anionic group-containing water-insoluble resin or its solution in an organic solvent with a base compound (neutralizing agent) thereby carrying out neutralization; (2) mixing the obtained mixed solution with a pigment to make a suspension, and then dispersing the pigment with a disperser to obtain a pigment dispersion; and (3) removing the organic solvent by, for example, distillation thereby coating the pigment with the anionic group-containing specific water-insoluble resin, and dispersing the coated pigment particles in an aqueous medium to make an aqueous dispersion.

The method is further detailed in JP-A Nos. 11-209672 and 11-172180.

In the invention, the dispersion treatment may be carried out using, for example, a ball mill, a roll mill, a bead mill, a high-pressure homogenizer, a high-speed stirring disperser, or an ultrasonic homogenizer.

The content of the pigment coated with water-insoluble resin in the invention is preferably from 1 to 10% by mass, more preferably from 2 to 8% by mass, and particularly preferably from 2 to 6% by mass from the viewpoints of the dispersion stability and concentration of the aqueous ink composition.

—Organic Solvent—

The aqueous ink composition in the invention contains at least one organic solvent. The organic solvent is used as an anti-drying agent, a humectant, or a penetration enhancing agent. The anti-drying agent is used for preventing clogging of inkjet nozzles caused by adhesion, drying, and aggregation of ink at the ink injection ports. The anti-drying agent or humectant is preferably a water-soluble organic solvent having a lower vapor pressure than water. The penetration enhancing agent is used to improve ink permeablilty through paper.

The organic solvent contained in the aqueous ink composition in the invention may be appropriately selected from known organic solvents which serve as an anti-drying agent, a humectant, or a penetration enhancing agent. From the viewpoint of compatibility with water, the organic solvent is preferably water-soluble.

Examples of water-soluble organic solvents include alkanediols (polyhydric alcohols) such as glycerin, 1,2,6-hexanetriol, trimethylolpropane, ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol; saccharides such as glucose, mannose, fructose, ribose, xylose, arabinose, galactose, aldonic acid, glucitol, maltose, cellobiose, lactose, sucrose, trehalose, and maltotriose; glycitols; hyaluronic acids; so-called solid humectants such as ureas; alkyl alcohols having 1 to 4 carbon atoms, such as ethanol, methanol, butanol, propanol, and isopropanol; glycol ethers such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, 1-methyl-1-methoxy butanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, and dipropylene glycol mono-iso-propyl ether; 2-pyrrolidone, N-methyl-2-pyrrolidone, 1,3-dimethyl-2-imidazolidinone, formamide, acetamido, dimethyl sulfoxide, sorbit, sorbitan, acetin, diacetin, triacetin, and sulfolane. These organic solvents may be used alone or in combination of two or more thereof.

As an anti-drying agent or a humectant, polyhydric alcohols are useful. Examples of the polyhydric alcohols include glycerin, ethylene glycol, diethylene glycol, triethylene glycol, propylene glycol, dipropylene glycol, tripropylene glycol, 1,3-butanediol, 2,3-butanediol, 1,4-butanediol, 3-methyl-1,3-butanediol, 1,5-pentanediol, tetraethylene glycol, 1,6-hexanediol, 2-methyl-2,4-pentanediol, polyethylene glycol, 1,2,4-butanetriol, and 1,2,6-hexanetriol. These polyhydric alcohols may be used alone or in combination of two or more thereof.

As a penetrating agent, polyol compounds are preferable. Examples of aliphatic diols include 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol, and 2-ethyl-1,3-hexanediol. Among them, 2-ethyl-1,3-hexanediol and 2,2,4-trimethyl-1,3-pentanediol are preferable.

The above-described organic solvents may be used alone or in combination of two or more thereof.

The content of the organic solvent in the aqueous ink composition is preferably from 1 to 60% by mass, and more preferably from 5 to 40% by mass.

—Water—

The aqueous ink composition in the invention contains water. The content of water is not particularly limited, and is preferably from 10 to 99% by mass, more preferably from 30 to 80% by mass, and even more preferably from 50 to 70% by mass.

—Neutralizing Agent—

The aqueous ink composition in the invention contains at least one neutralizing agent. The neutralizing agent is used for neutralizing acid groups contained in the water-insoluble resin during preparation of pigment particles coated with the water-insoluble resin. The amount of the neutralizing agent is preferably from 0.5 to 1.5 equivalents, and more preferably from 1 to 1.5 equivalents with respect to the acid number of the resin.

Examples of the neutralizing agent include alcohol amines (for example, diethanolamine, triethanolamine, 2-amino-2-ethyl-1,3-propanediol), alkali metal hydroxides (for example, lithium hydroxide, sodium hydroxide, potassium hydroxide), ammonium hydroxide (for example, ammonium hydroxide, quaternary ammonium hydroxide), phosphonium hydroxides, and alkali metal carbonates. Among them, sodium hydroxide and potassium hydroxide are preferably used.

—Surfactant—

The aqueous ink composition in the invention preferably contains at least one surfactant. The surfactant is used as a surface tension regulator. Examples of the surfactant include nonionic, cationic, anionic, and betaine surfactants.

In order to achieve good ink ejection, the surfactant is preferably used in an amount such that the the aqueous ink composition has a surface tension of 20 to 60 mN/m. Further, the surfactant is preferably used in an amount such that the surface tension is from 20 to 45 mN/m, and more preferably the surface tension is from 25 to 40 mN/m.

Examples of effective surfactants may include compounds containing hydrophilic and hydrophobic moieties within one molecule thereof. The surfactant may also be anionic, cationic, ampholytic, or nonionic.

Specific examples of the anionic surfactants include sodium dodecylbenzene sulfonate, sodium lauryl sulfate, sodium alkyl diphenyl ether disulfonate, sodium alkyl naphthalene sulfonate, sodium dialkyl sulfosuccinate, sodium stearate, potassium oleate, sodium dioctyl sulfosuccinate, sodium polyoxyethylene alkyl ether sulfate, sodium polyoxyethylene alkyl phenyl ether sulfate, sodium dialkyl sulfosuccinate, sodium stearate, sodium oleate, and sodium t-octylphenoxy ethoxypolyethoxyethyl sulfate. These anionic surfactancs may be used alone or in combination of two or more thereof.

Specific examples of the nonionic surfactants include poly(oxyethylene)lauryl ether, poly(oxyethylene)octylphenyl ether, poly(oxyethylene)oleylphenyl ether, poly(oxyethylene)nonylphenyl ether, oxyethylene-oxypropylene block copolymer, t-octylphenoxyethylpolyethoxyethanol, and nonylphenoxyethyl polyethoxyethanol. These nonionic surfactants may be used alone or in combination of two or more thereof.

Examples of the cationic surfactants include tetraalkyl ammonium salts, alkylamine salts, benzalkonium salts, alkylpyridium salts, and imidazolium salts, and specific examples thereof include dihydroxyethylstearylamine, 2-heptadecenyl-hydroxyethylimidazoline, lauryldimethylbenzylammonium chloride, cetylpyridinium chloride, and stearamidomethylpyridinium chloride.

The content of the surfactant in the aqueous ink composition is not particularly limited, and is preferably 1% by mass or more, more preferably 1 to 10% by mass, and even more preferably 1 to 3% by mass.

—Other Components—

The aqueous ink composition in the invention may contain, in addition to the above-described components, optionally, other components such as resin fine particles or a polymer latex, an ultraviolet absorber, an anti-fading agent, a fungicide, a rust preventive agent, an antioxidant, an emulsification stabilizer, a preservative, an anti-foaming agent, a viscosity regulator, a dispersion stabilizer, and a chelating agent.

Examples of the resin fine particles include fine particles of acrylic resins, vinyl acetate resins, styrene-butadiene resins, vinyl chloride resins, acryl-styrene resins, butadiene resins, styrenic resins, crosslinked acrylic resins, crosslinked styrenic resins, benzoguanamine resins, phenolic resins, silicone resins, epoxy resins, urethane resins, paraffin resins, and fluorine resins. These resins may be used in the form of polymer latexes including these resins.

Among the above resins, acrylic resins, acryl-styrene resins, styrenic resins, crosslinked acrylic resins, and crosslinked styrenic resins are preferable.

The weight average molecular weight of the resin fine particles is preferably 10000 or more but 200000 or less, and more preferably 100000 or more but 200000 or less.

The average particle diameter of the resin fine particle is preferably from 10 nm to 1 μm, more preferably from 10 to 200 nm, even more preferably from 20 to 100 nm, and particularly preferably from 20 to 50 nm. The addition amount of the resin fine particles is preferably from 0.5 to 20% by mass, more preferably from 3 to 20% by mass, and even more preferably from 5 to 15% by mass with respect to the ink.

The glass transition temperature (Tg) of the resin fine particles is preferably 30° C. or higher, more preferably 40° C. or higher, and even more preferably 50° C. or higher.

The polymer particles are not particularly limited as to their particle diameter distribution, and may have a broad particle diameter distribution or a monodispersed particle diameter distribution. Alternatively, a mixture of two or more kinds of polymer fine particles each having a monodispersed particle diameter distribution may be used.

Examples of the ultraviolet absorber include benzophenone ultraviolet absorbers, benzotriazole ultraviolet absorbers, salicylate ultraviolet absorbers, cyanoacrylate ultraviolet absorbers, and nickel complex salt ultraviolet absorbers.

The anti-fading agent may be selected from various organic and metal complex anti-fading agents. Examples of the organic anti-fading agents include hydroquinones, alkoxy phenols, dialkoxy phenols, phenols, anilines, amines, indans, chromanes, alkoxy anilines, and heterocycles. Examples of the metal complexes include nickel complexes and zinc complexes.

Examples of the fungicide include sodium dehydroacetate, sodium benzoate, sodium pyridinethione-1-oxide, p-hydroxybenzoic acid ethyl ester, 1,2-benzisothiazoline-3-one, sodium sorbate, and sodium pentachlorophenolate. The content of the fungicide in an ink is preferably from 0.02 to 1.00% by mass.

Examples of the rust preventive agent include acidic sulfites, sodium thiosulfate, ammonium thioglycolate, diisopropyl-ammonium nitrite, pentaerythritol tetranitrate, and dicyclohexylammonium nitrite.

Examples of the antioxidant include phenol antioxidants (including hindered phenol antioxidants), amine antioxidants, sulfur containing antioxidants, and phosphorus containing antioxidants.

Examples of the chelating agent include sodium ethylenediamine tetraacetate, sodium nitrilotriacetate, sodium hydroxyethyl-ethylnediamine triacetate, sodium diethylenetriamine pentaacetate, and sodium uramildiacetate.

—Physical Properties of Aqueous Ink Composition—

The surface tension (25° C.) of the aqueous ink composition in the invention is preferably 20 mN/m or more but 60 mN/m or less, more preferably 20 mN/m or more but 45 mN/m or less, and even more preferably 25 mN/m or more but 40 mN/m or less.

The surface tension is measured with an aqueous ink at 25° C. using Automatic Surface Tensiometer CBVP-Z (manufactured by Kyowa Interface Science Co., Ltd.).

The aqueous ink composition in the invention preferably has a viscosity (at 20° C.) of 1.2 mPa·s or more but 15.0 mPa·s or less, more preferably 2 mPa·s or more but less than 13 mPa·s, and even more preferably 2.5 mPa·s or more but less than 10 mPa·s.

The viscosity is measured with an aqueous ink at 20° C. using VISCOMETER TV-22 (manufactured by Toki Sangyo Co., Ltd.).

The aqueous ink composition in the invention may be used for the formation of a multi-color image (for example, a full color image). For the formation of a full color image, ink compositions having magenta, cyan, and yellow colors may be used, and additionally an ink composition having a black color may also be used to adjust the color tone.

In addition to the yellow (Y), magenta (M), and cyan (C) color ink compositions, other ink compositions such as those having red (R), green (G), blue (B), and white (W) colors, or those having so-called special colors used in the printing field may be used.

The ink compositions having intended colors are prepared by changing as desired the color pigment used as the coloring agent.

(Aqueous Liquid Composition)

The aqueous liquid composition in the inkjet recording ink set of the invention contains at least one aggregating component for aggregating the pigment in the aqueous ink composition when the aqueous liquid composition is mixed with the aqueous ink composition, and optionally may further contain other components.

—Aggregating Component—

The aqueous liquid composition in the invention contains at least one aggregating component for aggregating the pigment in the aqueous ink composition. The aqueous liquid composition is mixed with the aqueous ink composition ejected by an inkjet method, thereby promoting the aggregation of the pigment stably dispersed in the aqueous ink composition.

Examples of the aqueous liquid composition include a liquid composition which may form aggregate by changing the pH of the aqueous ink composition. In this case, the pH of the aqueous liquid composition (25° C.) is preferably 6 or less, and more preferably 4 or less. In particular, the pH (25° C.) is preferably from 1 to 4, and particularly preferably from 1 to 3. In this case, the pH of the aqueous ink composition (25° C.) is preferably 7.5 or more, and more preferably 8 or more.

In the invention, from the viewpoints of image density, resolution, and speedup of inkjet recording, it is particularly preferable that the pH of the aqueous ink composition (25° C.) be 7.5 or more, and the pH of the aqueous liquid composition (25° C.) be 4 or less.

Examples of the aggregating component for aggregating the pigment include multivalent metal salts, organic acids, polyallylamines, and derivatives thereof.

Examples of the multivalent metal salts may include salts of alkaline earth metals of group 2 in the periodic table (for example, magnesium and calcium), transition metals of group 3 in the periodic table (for example, lanthanum), cations of group 13 in the periodic table (for example, aluminum), and lanthanides (for example, neodymium). Among these metal salts, carboxylates (for example, formates, acetates, and benzoates), nitrates, chlorides, and thiocyanates are preferable. Among them, calcium or magnesium salts of carboxylates (for example, formates, acetates, and benzoates), calcium or magnesium salts of nitrates, calcium chloride, magnesium chloride, and calcium or magnesium salts of thiocyanates are particularly preferable.

The organic acid may be appropriately selected from polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrolecarboxylic acid, furancarboxylic acid, pyridinecarboxylic acid, coumaric acid, thiophenecarboxylic acid, nicotinic acid, derivatives of these compounds, and salts of these compounds.

The aggregating component may be used alone or in combination of two or more thereof.

The content of the aggregating component for aggregating the pigment in the aqueous liquid composition is preferably from 1 to 20% by mass, more preferably from 5 to 20% by mass, and even more preferably from 10 to 20% by mass.

<Image Recording Method>

The image recording method of the invention includes an ink application step of applying the aqueous ink composition in the invention, which contains a water-insoluble resin (water-insoluble resin including the structural unit represented by the formula (I)), a pigment, an organic solvent, a neutralizing agent, and water, onto a recording medium by an inkjet method, and an aggregating component application step of applying an aqueous liquid composition, which contains a component for aggregating the pigment in the aqueous ink composition, onto the recording medium, wherein the aqueous ink composition is brought into contact with the aqueous liquid composition thereby forming an image.

In the image recording method of the invention, when an image is recorded through the aggregation caused by the contact between the aqueous ink composition and aqueous liquid composition at the time of recording, since the aqueous ink composition containing the pigment coated with the water-insoluble resin including the structural unit represented by the formula (I) is used, the adhesion or deposition of aggregate on the liquid ejection portion formed by the contact between the two liquids is impeded, and the removal of the aggregate attached thereto is facilitated. As a result, directional failure of ink ejection is suppressed when the ink is ejected, and the occurrence of image defects such as white spots is prevented, whereby high resolution image may be recorded. The decrease of the maintenance frequency of the ejection apparatus and improvement of the maintainability of the apparatus may also be achieved.

In the ink application step, the aqueous ink composition is applied by an inkjet method. More specifically, energy is applied thereby ejecting the aqueous ink composition onto a recording medium, for example, plain paper, resin coated paper, inkjet recording paper described in, for example JP-A Nos. 8-169172, 8-27693, 2-276670, 7-276789, 9-323475, 62-238783, 10-153989, 10-217473, 10-235995, 10-337947, 10-217597, and 10-337947, film, electrophotographic paper, cloth, glass, metal, or ceramic to form a color image. The method described in the paragraphs 0093 to 0105 in JP-A No. 2003-306623 may be applied as a preferable inkjet recording method in the invention.

The inkjet method is not limited, and may use a known system such as a charge controlling system of jetting ink using electrostatic attraction, a drop on demand system (pressure pulse system) of using vibratory pressure of piezo elements, an acoustic inkjet system of jetting ink using the radiation pressure of the ink caused by acoustic beam converted from an electric signal, and a thermal inkjet (Bubble Jet (registered trademark)) system of using a pressure generated by bubbles formed in the ink by heating. The inkjet method described in JP-A No. 54-59936 may be effectively used in which heat energy is applied to an ink to thereby abruptly change the ink volume, and the force exerted by the volume change makes the ink ejected from a nozzle.

Other examples of the inkjet method include a system of jetting many droplets of a low concentration ink, which is referred to as photo ink, at a small volume, a system of improving the image quality using a plurality of inks having substantially the same color and different concentrations, and a system of using a colorless and transparent ink.

The inkjet heads used in the inkjet method may be of on-demand or continuous type. Specific examples of the ejection system may include, but not limited to, an electromechanical conversion system (for example, single cavity type, double cavity type, bender type, piston type, share mode type, and shared wall type), electrothermal conversion system (for example, thermal inkjet type and Bubble Jet (registered trademark) type), electrostatic suction system (for example, electric field control type and slit jet type), and electrical discharge system (for example, spark jet type).

The ink nozzle and the like used for the inkjet recording are not particularly limited, and may be appropriately selected according to the intended use.

In the aggregating component application step, the aqueous liquid composition is applied onto the recording medium before or after the application of the aqueous ink composition. The application of the aqueous liquid composition may be performed by a known method such as a coating method, an inkjet method, or a dipping method. The application method may use a known means such as a bar coater, an extrusion die coater, an air doctor coater, a blade coater, a rod coater, a knife coater, a squeeze coater, a reverse roll coater, or a bar coater. The details about the inkjet method are the same as described above.

In the invention, it is preferable that the aggregating component application step of applying an aqueous liquid composition be followed by the ink application step. More specifically, according to a preferable embodiment of the invention, before the application of the aqueous ink composition, the aqueous liquid composition for aggregating the pigment in the aqueous ink composition is applied onto the recording medium, thereby bringing the aqueous ink composition into contact with the aqueous liquid composition applied on the recording medium to form an image. As a result of this, speedup of inkjet recording is achieved, and an image having a high density and high resolution is produced even by high-speed recording.

In the formation of an image, a polymer latex compound may also be used to impart glossiness and water resistance, and to improve weather resistance. The latex compound may be applied before, after, or at the same time of the application of the aqueous ink composition. Therefore, the latex compound may be applied to the recording medium, or contained in the aqueous ink composition, or used in another liquid state.

Specific examples thereof may include those described in JP-A Nos. 2002-166638 (Application No. 2000-363090), 2002-121440 (Application No. 2000-315231), 2002-154201 (Application No. 2000-354380), 2002-144696 (Application No. 2000-343944), and 2002-080759 (Application No. 2000-268952).

The image formation method of the invention may further include other steps in addition to the ink application step of applying an aqueous ink composition and the aggregating component application step of applying an aqueous liquid composition. The other steps are not particularly limited, and may be appropriately selected according to the intended use. Examples of the other steps include a drying removal step of drying and removing the organic solvent in the aqueous ink composition applied on the recording medium, and a fusing step of fusing the resin fine particles or polymer latex contained in the aqueous ink composition.

In another example of the image formation method of the invention, an intermediate transfer medium is used as the recording medium on which an image is to be formed, and the method includes an ink application step of applying an aqueous ink composition containing the water-insoluble resin (water-insoluble resin including the structural unit represented by the formula (I)), a pigment, an organic solvent, a neutralizing agent, and water onto the intermediate transfer medium by an inkjet method, and an aggregating component application step of applying an aqueous liquid composition containing a component for aggregating the pigment in the aqueous ink composition onto the intermediate transfer medium, wherein the aqueous ink composition is brought into contact with the aqueous liquid composition thereby forming an image on the intermediate transfer medium, and a transferring step of transferring the image formed on the intermediate transfer medium to a final recording medium.

The method may further include other steps such as a drying removal step and a fusing step in the same manner as in the above-described method.

According to the invention, the following embodiments <1> to <12> are provided.

<1> An ink set for inkjet recording, comprising:

an aqueous ink composition containing a pigment coated with a water-insoluble resin including a structural unit represented by the following formula (I), an organic solvent, a neutralizing agent, and water; and

an aqueous liquid composition containing a component which aggregates the pigment in the aqueous ink composition when the aqueous liquid composition is mixed with the aqueous ink composition:

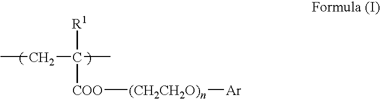

wherein R¹ represents a hydrogen atom or a methyl group, Ar represents an unsubstituted or substituted aromatic ring, and n represents an average number of repetition of 1 to 6.

<2> The ink set for inkjet recording of <1>, wherein the aromatic ring represented by Ar in the formula (I) is an unsubstituted or substituted benzene ring.

<3> The ink set for inkjet recording of <1>, wherein the water-insoluble resin comprises hydrophilic structural units (A) and hydrophobic structural units (B), at least one of the hydrophobic structural units (B) is the structural unit represented by the formula (I), the proportion of the hydrophilic structural units (A) is 15% by mass or less of the total mass of the water-insoluble resin, and the hydrophilic structural units (A) contain at least a structural unit derived from (meth)acrylic acid.

<4> The ink set for inkjet recording of <1>, wherein the water-insoluble resin has an acid number of 30 mgKOH/g to 100 mgKOH/g.

<5> The ink set for inkjet recording of <1>, wherein the water-insoluble resin has a weight average molecular weight of 30000 or more.

<6> The ink set for inkjet recording of <1>, wherein the aqueous liquid composition comprises a multivalent metal salt or an organic acid.

<7> The ink set for inkjet recording of <1>, wherein the aqueous ink composition has a pH of 7.5 or more at 25° C., and the aqueous liquid composition has a pH of 4 or less at 25° C.

<8> The ink set for inkjet recording of <1>, comprising a plurality of the aqueous ink composition including at least a black ink composition, a cyan ink composition, a magenta ink composition, and a yellow ink composition.

<9> The ink set for inkjet recording of <1>, wherein the aqueous ink composition further comprises a surfactant, and the organic solvent contains at least a water-soluble organic solvent.

<10> An image recording method, comprising:

applying an aqueous ink composition to a recording medium by an inkjet method, the aqueous ink composition containing a water-insoluble resin including a structural unit represented by the following formula (I), a pigment, an organic solvent, a neutralizing agent, and water; and

applying an aqueous liquid composition to the recording medium, the aqueous liquid composition containing a component for aggregating the pigment in the aqueous ink composition,

wherein the aqueous ink composition is brought into contact with the aqueous liquid composition, thereby forming an image:

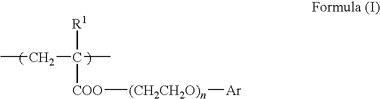

wherein R¹ represents a hydrogen atom or a methyl group, Ar represents an unsubstituted or substituted aromatic ring, and n represents an average number of repetition of 1 to 6.

<11> The image recording method of <10>, wherein the aromatic ring represented by Ar in the formula (I) is an unsubstituted or substituted benzene ring.

<12> The image recording method of <10>, wherein the applying of the aqueous liquid composition to the recording medium is performed prior to the applying of the aqueous ink composition to the recording medium, and the aqueous ink composition is applied to the recording medium so as to contact the aqueous liquid composition applied to the recording medium, thereby forming the image.

Therefore, according to the invention, an ink set for inkjet recording and an image formation method using the same are provided which impede the adhesion and deposition of the aggregate, provide good removability (maintainability) of the attached aggregate, and inhibit the occurrence of image defects such as white spots, thus achieving image formation with high resolution.

### EXAMPLES

The invention is further described with reference to the following examples, but the invention is not limited thereto. Unless otherwise noted, “part” indicates part by mass.

The weight average molecular weight was measured by gel permeation chromatography (GPC). The GPC is carried out with HLC-8020 GPC (manufactured by Tosoh Corporation), three columns (trade name: TSKgel, SUPER Multipore HZ-H, manufactured by Tosoh Corporation, 4.6 mm ID×15 cm), and THF (tetrahydrofuran) as the eluate. The sample concentration was 0.35% by mass, the flow rate was 0.35 ml/min, the sample injection amount was 10 μl, the measurement temperature was 40° C., and an IR detector was used. The calibration curve was prepared using eight samples “standard sample TSK standard, polystyrene”: “F-40”, “F-20”, “F-4”, “F-1”, “A-5000”, “A-2500”, “A-1000”, and “n-propyl benzene” manufactured by Tosoh Corporation.

### Synthesis Example 1

—Synthesis of Resin Dispersant P-1—

88 g of methyl ethyl ketone was placed in a 1000-ml three-necked flask equipped with a stirrer and a cooling tube, heated to 72° C. in a nitrogen atmosphere. Into the flask, a solution prepared by dissolving 0.85 g of dimethyl-2,2′-azobisisobutylate, 70 g of phenoxyethyl methacrylate, 10 g of methacrylic acid, and 20 g of methyl methacrylate in 50 g of methyl ethyl ketone was added dropwise over a period of 3 hours. After completion of the addition, the reaction was continued for further one hour, and then a solution prepared by dissolving 0.42 g of dimethyl-2,2′-azobisisobutylate in 2 g of methyl ethyl ketone was added into the flask, and the solution was heated at 78° C. for 4 hours. The reaction solution thus obtained was reprecipitated twice in excess amounts of hexane, and the precipitated resin was dried to obtain 96.5 g of a phenoxyethyl methacrylate/methyl methacrylate/methacrylic acid (copolymerization ratio [molar ratio]=70/20/10) copolymer (resin dispersant P-1).

The composition of the resin dispersant P-1 thus obtained was confirmed by ¹H-NMR. Its weight average molecular weight (Mw) was 49400 as determined by GPC. The acid number of the polymer was 65.2 mgKOH/g as determined by the method described in Japanese Industrial Standard (JIS K 0070:1992).

—Synthesis of Resin Dispersants P-2 to P-4—

Resin dispersants P-2, P-3, and P-4 were synthesized in the substantially same manner as in the synthesis of the resin dispersant P-1, except that 70 g of phenoxyethyl methacrylate, 10 g of methacrylic acid, and 20 g of methyl methacrylate were changed as listed in Table 1.

### Example 1

—Preparation of Dispersion of Resin-Coated Pigment Particles—

10 parts of Pigment Blue 15:3 (phthalocyanine blue A220, manufactured by Dainichiseika Color & Chemicals Mfg. Co., Ltd.), 4.5 parts of the phenoxyethyl methacrylate/methyl methacrylate/methacrylic acid copolymer (resin dispersant P-1), 42 parts of methyl ethyl ketone, 5.5 parts of 1 N NaOH aqueous solution, and 87.2 parts of ion exchange water were mixed together, and the mixture was dispersed for 2 to 6 hours in a bead mill together with zirconia beads having a diameter of 0.1 mm. Subsequently, methyl ethyl ketone was removed from the dispersion at 55° C. under reduced pressure, and water was partially removed to obtain a dispersion of resin-coated pigment particles with a pigment concentration of 10.2% by mass.

—Particle Diameter Measurement of Resin-Coated Pigment Particles—

The dispersion of resin-coated pigment particles obtained was measured with a NANOTRAC particle size distribution analyzer UPA-EX150 (manufactured by Nikkiso Co., Ltd.) to determine the volume average particle diameter by a dynamic light scattering method. For the measurement, 10 ml of ion exchange water was added to 10 μl of the dispersion of resin-coated pigment particles to make a sample solution, and the temperature of the solution was adjusted to 25° C. The measurement results are listed in Table 1.

—Preparation of Aqueous Ink—

Using the dispersion of resin-coated pigment particles, an aqueous ink was prepared according to the following composition. The aqueous ink has a pH of 8.9 at 25° C.

<Composition>

| | | |
|---|---|---|
| Dispersion of resin-coated pigment particles | 38.2 | parts |
| Glycerin | 15 | parts |
| Diethylene glycol monoethyl ether | 5 | parts |
| OLFIN E1010 (manufactured by Nisshin Chemical | 1 | part |
| Industry Co., Ltd.) | | |
| Ion exchange water | 40.8 | parts |

—Preparation of Aggregating Solution—

The following components were mixed together to make an aqueous aggregating solution (aqueous liquid composition). In the measurements of physical properties, the aggregation solution had a viscosity of 4.9 mPa·s, a surface tension of 24.3 mN/m, and a pH of 1.5.

<Composition>

| | |
|---|---|
| Citric acid (manufactured by Wako Pure Chemical | 16.7% by mass |
| Industries, Ltd.) | |
| Diethylene glycol monoethyl ether (manufactured by | 20.0% by mass |
| Wako Pure Chemical Industries, | |
| Zonyl FSN-100 (manufactured by Du Pont K.K.) | 1.0% by mass |
| Ion exchange water | 62.3% by mass |

As described above, an ink set of a cyan color aqueous ink and an aqueous aggregating solution was prepared.

—Evaluation of Ink Set—

The ink set obtained as described above was loaded into an inkjet apparatus having prototype print heads each having 600 dpi and 256 nozzles, and the occurrence of white spots was evaluated by the following method. The recording medium was FX-L paper (manufactured by Fuji Xerox Co., Ltd.).

—Evaluation of White Spots—

The aqueous aggregating solution and aqueous ink obtained were ejected in this order from separate heads onto the FX-L paper for 30 minutes. Subsequently, as a maintenance operation, the heads were subjected to a pressure of 15 KPa for 10 seconds, and wiped with CLEAN WIPER FF-390c (manufactured by Kuraray Co., Ltd.). Thereafter, ink ejection was further continued for 5 minutes, and the image (5 cm×5 cm) recorded on the FX-L paper after 5 minutes was observed. The observed image was evaluated based on the following visual observation criteria.

<Criteria>

A: no white spots

B: two or less white spots

C: three to ten white spots

D: more than ten white spots

### Examples 2 to 4

Dispersions of resin-coated pigment particles were prepared in the same manner as in Example 1, except that the phenoxyethyl methacrylate/methyl methacrylate/methacrylic acid copolymer (resin dispersant P-1) was changed to resin dispersants P-2, P-3, and P-4 as listed in Table 1. In the same manner as in Example 1, these dispersions were subjected to the measurement of particle diameter, and aqueous inks were prepared from these dispersions, and evaluation is carried out. The results of the measurement and evaluation are listed in Table 1.

### Comparative Examples 1 to 3

Dispersions of resin-coated pigment particles were prepared in the same manner as in Example 1, except that the phenoxyethyl methacrylate/methyl methacrylate/methacrylic acid copolymer (resin dispersant P-1) was changed to a benzyl methacrylate/methacrylic acid (=90/10 [% by mass]) copolymer (Comparative Example 1), a benzyl methacrylate/methacrylic acid (=80/20 [% by mass]) copolymer (Comparative Example 2), and a styrene/methacrylic acid (90/10 [% by mass]) copolymer (Comparative Example 3) as listed in Table 1. In the same manner as in Example 1, these dispersions were subjected to the measurement of particle diameter, and aqueous inks were prepared from these dispersions, and evaluation is carried out. The results of the measurement and evaluation are listed in Table 1.

TABLE 1

| | | | | | | | Particle | |
|---|---|---|---|---|---|---|---|---|
| | Water-insoluble resin | | | | pH of | pH of | diameter of | White |
| | | | Weight average | Acid number | aqueous | aggregating | dispersion | spots |
| | | Type (% by mass) | molecular weight | [mgKOH/g] | ink | solution | [nm] | evaluation |
| Example 1 | P-1 | Phenoxyethyl methacrylate/methyl | 49400 | 65.2 | 8.9 | 1.5 | 105 | B |
| | | methacrylate/methacrylic acid | | | | | | |
| | | copolymer (=70/20/10) | | | | | | |
| Example 2 | P-2 | Phenoxyethyl methacrylate/ethyl | 45300 | 78.2 | 8.9 | 1.5 | 99 | A |
| | | methacrylate/methacrylic acid | | | | | | |
| | | copolymer (=50/38/12) | | | | | | |
| Example 3 | P-3 | Phenoxyethyl acrylate/ethyl | 48200 | 77.9 | 8.9 | 1.5 | 103 | A |
| | | acrylate/acrylic acid copolymer | | | | | | |
| | | (=45/45/10) | | | | | | |
| Example 4 | P-4 | Structure A/butyl acrylate/acrylic | 38600 | 77.9 | 8.9 | 1.5 | 115 | B |
| | | acid copolymer (=70/20/10) | | | | | | |

| | | | | | | | |
|---|---|---|---|---|---|---|---|
| Comparative | Benzyl methacrylate/methacrylic acid | 46300 | 65.2 | 8.9 | 1.5 | 108 | C |
| Example 1 | copolymer (=90/10) | | | | | | |
| Comparative | Benzyl methacrylate/methacrylic acid | 43200 | 130.4 | 8.9 | 1.5 | 115 | D |
| Example 2 | copolymer (=80/20) | | | | | | |
| Comparative | Styrene/methacrylic acid copolymer | 38500 | 65.2 | 8.9 | 1.5 | 125 | C |
| Example 3 | (=90/10) | | | | | | |

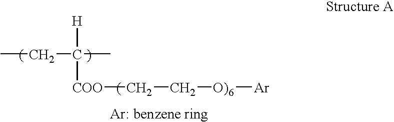

The results in Table 1 indicates that Examples prevented the occurrence of directional failure of ink ejection caused by the adhesion of aggregate to the heads, thus suppressing the occurrence of white spots in the recorded image. In addition, the amount of the adhesion of aggregate of the two liquids formed by the generation of mist was small, and the attached aggregate were readily removed, resulting in the easy and facilitated maintenance.

On the other hand, Comparative Examples underwent heavy adhesion of aggregate to the heads, did not prevent the directional failure of ink ejection, and thus could not suppress the occurrence of white spots.

In the above-described Examples, a cyan color ink composition was prepared as the aqueous ink composition. However, the type (color) of the pigment to be used in the cyan color ink composition may be changed in the above-described procedure to obtain aqueous ink compositions having various colors such as black, magenta, and yellow. In addition, two or more aqueous color inks may be loaded into the inkjet apparatus in the above-described procedure to record a multi-color image, thus providing the same results and effects as those described above.

All publications, patent applications, and technical standards mentioned in this specification are herein incorporated by reference to the same extent as if each individual publication, patent application, or technical standard was specifically and individually indicated to be incorporated by reference.

What is claimed is:

1. An ink set for inkjet recording, comprising:
an aqueous ink composition containing a pigment coated with a water-insoluble resin including a structural unit represented by the following formula (I), an organic solvent, a neutralizing agent, and water; and
an aqueous liquid composition containing a component which aggregates the pigment in the aqueous ink composition when the aqueous liquid composition is mixed with the aqueous ink composition: 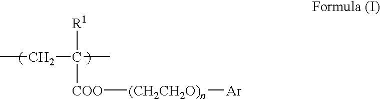
wherein R¹ represents a hydrogen atom or a methyl group, Ar represents an unsubstituted or substituted aromatic ring, and n represents an average number of repetition of 1 to 6.

2. The ink set for inkjet recording of claim 1, wherein the aromatic ring represented by Ar in the formula (I) is an unsubstituted or substituted benzene ring.

3. The ink set for inkjet recording of claim 1, wherein the water-insoluble resin comprises hydrophilic structural units (A) and hydrophobic structural units (B), at least one of the hydrophobic structural units (B) is the structural unit represented by the formula (I), the proportion of the hydrophilic structural units (A) is 15% by mass or less of the total mass of the water-insoluble resin, and the hydrophilic structural units (A) contain at least a structural unit derived from (meth)acrylic acid.

4. The ink set for inkjet recording of claim 1, wherein the water-insoluble resin has an acid number of 30 mgKOH/g to 100 mgKOH/g.

5. The ink set for inkjet recording of claim 1, wherein the water-insoluble resin has a weight average molecular weight of 30000 or more.

6. The ink set for inkjet recording of claim 1, wherein the aqueous liquid composition comprises a multivalent metal salt or an organic acid.

7. The ink set for inkjet recording of claim 1, wherein the aqueous ink composition has a pH of 7.5 or more at 25° C., and the aqueous liquid composition has a pH of 4 or less at 25° C.

8. The ink set for inkjet recording of claim 1, comprising a plurality of the aqueous ink composition including at least a black ink composition, a cyan ink composition, a magenta ink composition, and a yellow ink composition.

9. The ink set for inkjet recording of claim 1, wherein the aqueous ink composition further comprises a surfactant, and the organic solvent contains at least a water-soluble organic solvent.

10. An image recording method, comprising:
applying an aqueous ink composition to a recording medium by an inkjet method, the aqueous ink composition containing a water-insoluble resin including a structural unit represented by the following formula (I), a pigment, an organic solvent, a neutralizing agent, and water; and
applying an aqueous liquid composition to the recording medium, the aqueous liquid composition containing a component for aggregating the pigment in the aqueous ink composition,
wherein the aqueous ink composition is brought into contact with the aqueous liquid composition, thereby forming an image: 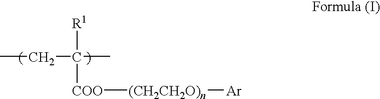
wherein R¹ represents a hydrogen atom or a methyl group, Ar represents an unsubstituted or substituted aromatic ring, and n represents an average number of repetition of 1 to 6.

11. The image recording method of claim 10, wherein the aromatic ring represented by Ar in the formula (I) is an unsubstituted or substituted benzene ring.

12. The image recording method of claim 10, wherein the applying of the aqueous liquid composition to the recording medium is performed prior to the applying of the aqueous ink composition to the recording medium, and the aqueous ink composition is applied to the recording medium so as to contact the aqueous liquid composition applied to the recording medium, thereby forming the image.
